(19) United States
(12) Patent Application Publication
(10) Pub. No.: US 2026/0027640 A1
(43) Pub. Date: Jan. 29, 2026

(54) Systems and Methods of Nozzles for Cryogenic Fluids

(71) Applicant: Relativity Space, Inc., Long Beach, CA (US)

(72) Inventors: Jenna Johns, Long Beach, CA (US); Fritz C. Gruber, Long Beach, CA (US); Jeremy Krol, Long Beach, CA (US); Michael Reid, Long Beach, CA (US)

(73) Assignee: Relativity Space, Inc., Long Beach, CA (US)

(21) Appl. No.: 19/283,112

(22) Filed: Jul. 28, 2025

Related U.S. Application Data
(60) Provisional application No. 63/676,846, filed on Jul. 29, 2024.

(51) Int. Cl. B23K 9/04; B33Y 40/00

(52) U.S. Cl. CPC B23K 9/044; B33Y 40/00

(57) ABSTRACT

Systems and methods for nozzles that can provide cryogenic shielding during wire-based additive manufacturing are described. Cryogenic fluid supplied by the cryogenic nozzles can provide ample coverage, great shielding, and efficient cooling during additive manufacturing processes.

### CROSS-REFERENCE TO RELATED APPLICATION

The current application claims the benefit of and priority under 35 U.S.C. § 119 (e) to U.S. Provisional Patent Application No. 63/676,846 entitled “Systems and Methods of Nozzles for Cryogenic Fluids”, filed Jul. 29, 2024, the disclosure of which is incorporated herein by reference in its entirety for all purposes.

### FIELD OF THE INVENTION

This application generally refers to systems and methods for nozzles. More specifically, this application relates to systems and methods for nozzles using cryogenic fluids for shielding and cooling.

### BACKGROUND

Additive manufacturing is a process by which a part is manufactured by adding one layer of material on top of another in a sequence or pattern that results in the part being built. This method of manufacturing is commonly referred to as three dimensional or 3-D printing and can be done with different materials, including plastic and metal.

Wire-based 3-D printing of metallic structures typically involves using an energy source to create a weld pool, and feeding a metal wire (feed material) into the weld pool by way of a printing head or printing head nozzle. Energy is used to create the weld pool. Some systems use electricity and others use lasers as the energy source. Electric systems typically pass an electric current through the feed wire into the weld pool. The printing head, and subsequently the weld pool can be moved. As the printing head and the weld pool moves, the trailing edge of the pool cools and solidifies. By this process of gradually moving the printing head along a path, and depositing one layer on top of a previous layer, a part is fully printed.

The process that deposits material can be improved by the use of shielding gas around the feed material. The shielding gas can help to make a better weld pool for an overall better part. The shielding gas can protect the weld pool from corrosive gases and moisture. Carbon dioxide, argon, helium, and oxygen are common shielding gases used in the welding processes.

### SUMMARY OF THE INVENTION

Systems and methods in accordance with some embodiments of the invention are directed to cryogenic nozzles for wire arc additive manufacturing.

Some embodiments include a nozzle, comprising: a nozzle head configured to couple with a welding torch, wherein the nozzle head is configured to connect to at least one cryogenic fluid; a heat plate comprising a plurality of heating elements; a shower plate comprising a plurality of holes, wherein the shower plate and the heat plate are coupled together with a snap ring, and wherein the plurality of heating elements are configured to heat the plate to prevent condensation from forming; wherein the at least one cryogenic fluid is configured to flow through the plurality of holes such that the at least one cryogenic fluid expands in volume when exiting the plurality of holes to form a gas shroud.

In some embodiments, the gas shroud is configured to form a self-enclosed environment that shields a heated area during an additive manufacturing process from an ambient environment.

In some embodiments, the welding torch is a MIG torch or a TIG torch.

In some embodiments, the welding torch is configured to accommodate a feed wire and a shielding gas, and wherein a heat source is configured to melt the feed wire to form a molten feed wire, and wherein the molten feed wire is configured to be deposited on a substrate during an additive manufacturing process.

In some embodiments, a tip of the feed wire extends through an opening of the shower plate, and wherein the gas shroud shields the molten feed wire during the additive manufacturing process.

In some embodiments, the shielding gas is selected from the group consisting of: argon, helium, carbon dioxide, nitrogen, hydrogen, neon, and xenon.

In some embodiments, the at least one cryogenic fluid is selected from the group consisting of: cryogenic liquid argon, cryogenic liquid nitrogen, cryogenic liquid helium, cryogenic liquid neon, cryogenic liquid oxygen, cryogenic liquid xenon, cryogenic argon gas, cryogenic nitrogen gas, cryogenic helium gas, cryogenic neon gas, cryogenic oxygen gas, cryogenic xenon gas, and cryogenic air.

In some embodiments, the plurality of heating elements are configured to connect with a power source.

In some embodiments, the nozzle head and the shower plate each have a plurality of connecting holes, and wherein the nozzle head and the plate are connected via the plurality of connecting holes.

Some embodiments include a method for shielding in wire arc additive manufacturing (WAAM), comprising: feeding a cryogenic fluid into a cryogenic nozzle, wherein the cryogenic nozzle comprises: a nozzle head configured to couple with a welding torch; a heat plate comprising a plurality of heating elements; a shower plate comprising a plurality of holes, wherein the shower plate and the heat plate are coupled together with a snap ring; wherein the cryogenic fluid flows through the plurality of holes and expands in volume when exiting the cryogenic nozzle, and wherein the plurality of heating elements are configured to heat the shower plate to prevent condensation of the cryogenic fluid on the cryogenic nozzle.

In some embodiments, the cryogenic fluid has a temperature lower than or equal to −190° C.

Some embodiments further comprise connecting a cryogenic supply with the cryogenic nozzle via a vacuum seal.

Some embodiments include a method for WAAM, comprising: feeding a wire through a weld torch; flowing a shielding gas through the weld torch such that the shielding gas surrounds the feed wire; melting the wire using an arc and depositing the melted wire on a substrate to form an article; and flowing a cryogenic fluid through a cryogenic nozzle coupled to the weld torch during deposition such that the cryogenic fluid expands in volume when exiting the cryogenic nozzle to form a secondary gas shield around the melted wire and the article.

In some embodiments, the secondary gas shield from the cryogenic fluid prevents the article from oxidizing.

Some embodiments include a cryogenic shielding nozzle assembly comprising a nozzle body with an inlet portion and a flange portion; wherein the nozzle body is configured to receive a cryogenic fluid from a cryogenic source via a hose coupled to a fluid inlet disposed on the inlet portion of the nozzle body, and at least one mounting aperture is disposed on the flange portion of the nozzle body; wherein the nozzle body is configured to selectively couple to a weld nozzle such that the cryogenic shielding nozzle assembly concentrically surrounds at least a portion of the weld nozzle; wherein each of the at least one mounting aperture is configured to receive a fastener element configured to couple the cryogenic shielding nozzle assembly to a shower plate assembly; and wherein at least one outlet is disposed on the flange portion of the nozzle body, the at least one outlet being in fluid communication with the inlet and the shower plate assembly.

In some embodiments, the at least one mounting aperture is at least two mounting apertures disposed circumferentially about an axis of the nozzle body.

In some embodiments, the shower plate assembly comprises: a shower plate body with a central aperture configured to concentrically surround at least a portion of the flange portion of the nozzle body; a plurality of gas outlet holes disposed in an annular region of the shower plate body, each of the plurality of gas outlet holes being configured to discharge cryogenic fluid toward a target area; and wherein each of the plurality of gas outlet holes is configured with an angle relative to a central axis of the aperture.

In some embodiments, a plurality of the gas outlet holes are oriented at an oblique angle relative to the central axis for a radial gas shroud.

In some embodiments, the plurality of gas outlet holes are oriented perpendicular to the central axis for axial cryogenic flow toward the target area.

In some embodiments, the shower plate further comprises integral flow paths in fluid communication with each of the plurality of gas outlet holes and the at least one outlet.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1A illustrates a welding torch on a robotic arm.

FIG. 1B illustrates a cryogenic nozzle in accordance with an embodiment.

FIG. 1C illustrates an enlarged view of a shower plate of the cryogenic nozzle in accordance with an embodiment.

FIG. 1D illustrates a cryogenic nozzle attached to a welding torch and a robotic arm in accordance with an embodiment.

FIGS. 2A through 2C illustrate a disassembled cryogenic nozzle in accordance with an embodiment.

FIG. 3A illustrates the shower plate and the heat plate in accordance with an embodiment.

FIGS. 3B and 3C illustrate assembled shower plate and heat plate in accordance with an embodiment.

FIGS. 4A through 4G illustrate various parts of the attachment system in accordance with an embodiment.

FIG. 5 illustrates the flow of cryogenic fluid from the cryogenic nozzle in accordance with an embodiment.

FIGS. 6A through 6D illustrate embodiments of a shower plate configured for use with a cryogenic nozzle assembly.

### DETAILED DESCRIPTION OF THE INVENTION

Systems and methods for cryogenic nozzles using cryogenic fluids for shielding and cooling are illustrated in the description herein. Many embodiments use cryogenic fluids including (but not limited to) cryogenic liquids (or cryogens) and/or cryogenic gases for shielding during wire-based additive manufacturing processes such as (but not limited to) wire arc additive manufacturing (WAAM) processes. The cryogenic sources have a temperature lower than or equal to about 120 Kelvin (or about −153 degree Celsius; or about −243 degree Fahrenheit). Cryogenic fluids can be pulled from storage tanks and sent to the cryogenic nozzles. The cryogenic nozzles dissipate the cryogenic fluids and provide ample shielding, coverage, and protection and efficient cooling during additive manufacturing processes.

Cryogenic shielding provided by the cryogenic nozzles in accordance with many embodiments can eliminate the need to use inert gas filled chambers. When additive manufacturing some metallic parts (such as, but not limited to, titanium parts, titanium alloy parts), the parts need to be placed in an evacuated chamber that is backfilled with inert gases to prevent oxidation, corrosion, or damage from environmental contaminants at elevated welding temperatures. In several embodiments, due to the ample coverage and shielding provided by the cryogenic nozzles, an evacuated chamber may not be needed during additive manufacturing processes. Cryogenic shielding can form a self-enclosed cryogenic environment to insulate the print part without a chamber. The need of evacuated chambers can restrict the sizes of the print parts and add additional procedures and cost for additive manufacturing processes. The use of the cryogenic nozzles in accordance with some embodiments can eliminate the chambers and simplify the printing processes while retaining the print quality and efficiency. Without the limitation of evacuated chambers, parts of any size can be printed.

In several embodiments, the cryogenic nozzles can be attached to various types of welding torches (or welding nozzles, or printing nozzles). Some embodiments fasten the cryogenic nozzles to the welding torches using brackets, fasteners, clamps, and/or seals. Examples of welding torches include (but are not limited to) metal inert gas (MIG) welding torches, tungsten inert gas (TIG) welding torches, and Fronius® MIG torches. The welding nozzles can be operated manually, semi-manually, and/or automatically. The welding torches can be controlled via at least one robotic arm. The at least one robotic arm can move the torches, with control from processors and/or computers, during additive manufacturing processes to carry out the printing processes. A feed wire (or feed wires) can be fed through the welding torches and melted by a heat source at the tip of the wire to form a weld pool. The heat source can be provided via electric arc, lasers, or other techniques. The weld pool can be deposited to a support structure (or a previously deposited layer of material) during printing. A shielding gas (such as, but not limited to, an inert gas, helium, argon, nitrogen, and/or carbon dioxide) can be flown down the welding torches to shield the feed wire(s) during printing. Several embodiments attach the cryogenic nozzle to a welding torch such that the cryogenic nozzle provides a secondary shielding, secondary cooling, or both, with a cryogenic fluid during printing.

In various embodiments, the cryogenic fluids can be sent down through the cryogenic nozzle to surround the tip of the feed wire. As soon as the cryogenic liquids touch the nozzle at room temperature, the liquids evaporate into gases and expand in volume. The expanded cryogenic gases can provide better shielding for the molten feed wires and the print part during printing.

Using cryogenic fluids for shielding in accordance with several embodiments can eliminate inert gas chambers, reduce solidification time of deposited materials, reduce heat build-up, and reduce expansion rate of the print articles. The simplified print set-up and fast-cooling processes due to the cryogenic shielding can improve the geometry and mechanical properties of the print articles. For various embodiments of this invention, cryogenic fluids include cryogenic liquids and cryogenic gases, unless otherwise specified.

### Cryogenic Nozzles

Additive manufacturing such as WAAM includes a protective environment that uses shielding gas in welding torches to protect the print part from oxidation and surrounding environmental factors. Shielding gas can be flown down a welding torch to surround the arc and the print part. The arc is encapsulated by the shielding gas shroud to keep the print part from oxidizing while heated. Argon (Ar) or a mixture of Ar and carbon dioxide (CO₂) are commonly used in WAAM as shielding gases. The shielding gas characteristics can be important because they may affect the mode of heat transfer, process stability, geometry and appearance of beads, surface waviness, deposition efficiency, and mechanical properties.

Many embodiments utilize cryogenic nozzles to provide cryogenic fluids for shielding, cooling, or both during WAAM processes, in addition to or instead of shielding gas flown down a welding torch. Cryogenic shielding in accordance with many embodiments can be applied to wire-based additive manufacturing in vertical orientations and/or in horizontal orientations. (See, e.g., printing orientations as described in U.S. Patent Publication No. 2024/0017340 to K. Konrath, et al., the disclosure of which is herein incorporated by reference.) Cryogenic nozzles in accordance with several embodiments can be attached to a weld torch. In several embodiments, cryogenic fluids can be pulled from the storage tanks into the cryogenic nozzles. A center opening of the cryogenic nozzles surrounds the tip of the weld torch and the feed wire(s). As the cryogenic fluids (at a temperature lower than about −153° C.) are in contact with the room temperature nozzle (between about 20° C. and about 30° C.), cryogenic liquids evaporate into gases and expand in volume. Shrouds of cryogenic gas from the cryogenic nozzle surrounds the shield gas (when used), the feed wire, the arc, and the print part during the printing processes. Shielding coverage can protect the molten material and/or the print part from forming oxides and from environmental contaminants. Several embodiments show that even excessive amounts of cryogenic shielding fluid do not extinguish the arc. The secondary shielding provided by the cryogenic nozzles can eliminate the use of chambers filled with inert gases and still prevent oxidation during additive manufacturing.

Cryogenic shielding can cool the print part rapidly during printing. Continuous deposition without cooling can produce excessive heat input in a local region, resulting in high temperatures and re-melting, and hence poor dimensional accuracy and surface finish. A common practice to prevent heat accumulation in WAAM can include introducing idle time between subsequent layer deposition. Another approach can be using active cooling systems to increase convection heat flux to the environment using water cooling and air-jet cooling, or in situ cooling with a thermoelectric. Many embodiments use cryogenic nozzles to provide cryogenic cooling to fast cool the print parts. The cryogenic fluids used for shielding and cooling have a temperature lower than or equal to about 120 Kelvin (or about −153° C.; or about −243° F.); or lower than or equal to about 83 Kelvin (or about −190° C.; or about −310° F.). The cryogenic temperature during the printing processes can reduce heat build-up and reduce the solidification time of deposited materials. The fast cooling and/or quenching as a result of cryogenic shielding can reduce the expansion rate of the print article and improve print qualities.

Various types of cryogenic fluids can be used for shielding and cooling in WAAM in accordance with many embodiments. Examples of cryogenic liquids include (but are not limited to) cryogenic liquid argon, cryogenic liquid nitrogen, cryogenic liquid helium, cryogenic liquid neon, cryogenic liquid oxygen, cryogenic liquid fluorine, cryogenic liquid methane, and any combinations thereof. Examples of cryogenic gases include (but are not limited to) cryogenic argon gas, cryogenic nitrogen gas, cryogenic helium gas, cryogenic neon gas, cryogenic oxygen gas, cryogenic fluorine gas, cryogenic methane gas, and any combinations thereof. Several embodiments use cryogenic argon liquid and cryogenic argon gas for shielding. Some embodiments use cryogenic nitrogen liquid and cryogenic nitrogen gas for shielding.

In several embodiments, the welding torches use a room temperature shielding gas, or a shielding gas above cryogenic temperature, (each a first shielding gas) for the feed wire(s). The cryogenic nozzles provide a cryogenic shielding gas, or a shielding gas cooler than the first shielding gas, (each a second shielding gas) during printing processes. In some embodiments, the first and the second shielding fluid or gas outlets can be positioned concentrically such that the second surrounds the first. In certain embodiments, the first shielding fluid or gas can be a room temperature shielding gas including (but not limited to) argon. The second shielding fluid or gas can be cryogenic argon or cryogenic nitrogen.

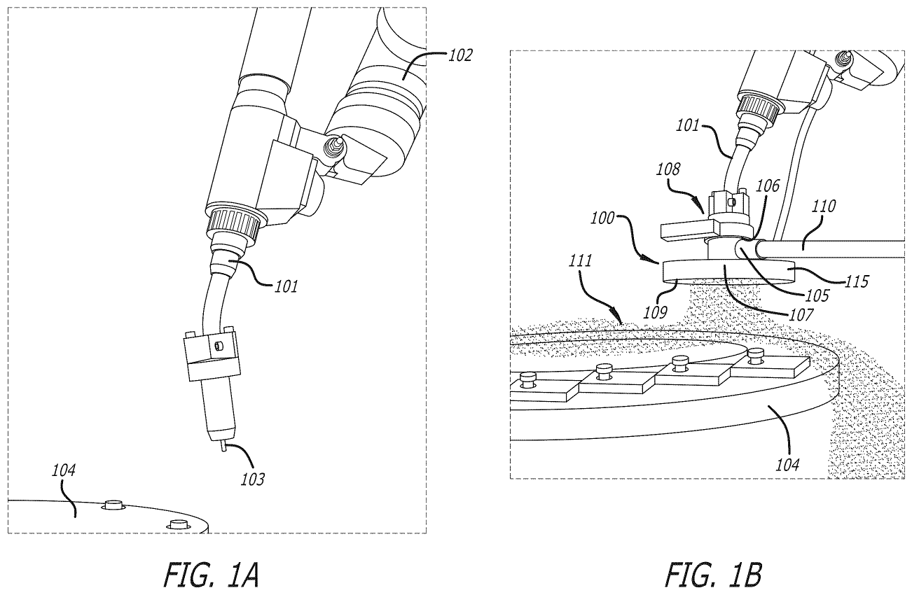

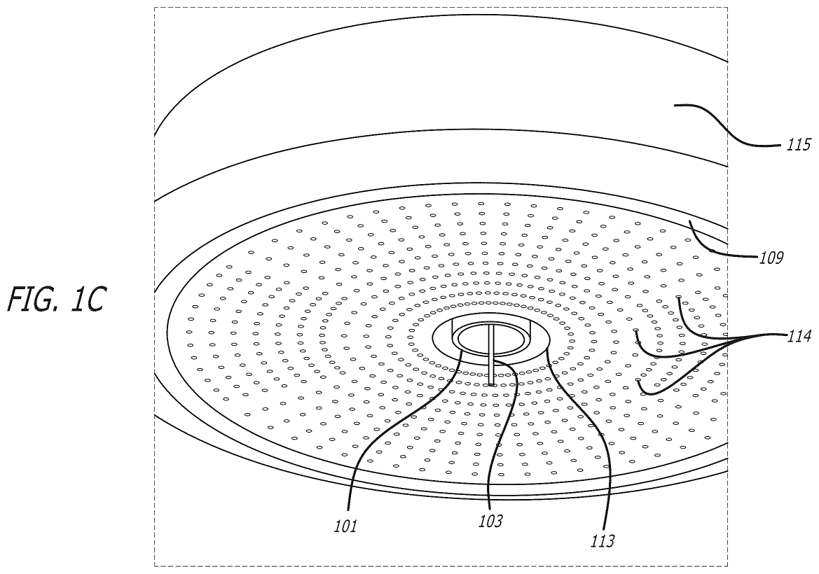

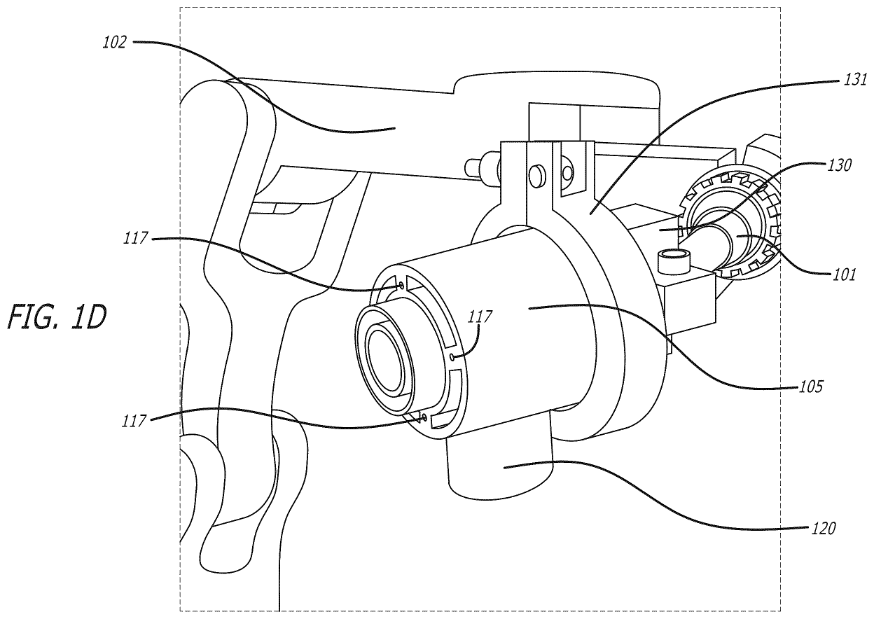

FIG. 1A illustrates a welding torch 101 attached to an end of robotic arm 102. A feed wire 103 can be fed through the welding torch 101. The feed wire 103 can be melted or vaporized and deposited on a substrate 104 or a previously deposited layer of a part (not shown) during additive manufacturing processes to form the part. As can be readily appreciated, the feed wire(s) can have various diameters and/or can be made of various metallic materials that are appropriate to the requirements of specific applications in accordance with various embodiments. (See, e.g., examples of feed wires are described in U.S. Patent Publication No. 2023/0313345 A1 to S. J. Tonneslan et al., the disclosure of which is herein incorporated by reference.) In certain embodiments, the feed wire(s) comprise titanium or titanium alloy. A shielding gas (not shown) can be supplied to the welding torch 101 during additive manufacturing processes to protect the molten wire. During printing, the robotic arm 102 and/or the substrate 104 can move to control the trajectory of the deposition of the feed wire 103.

FIG. 1B illustrates a cryogenic nozzle 100 in accordance with an embodiment. Cryogenic nozzle 100 can be attached to the welding torch 101. The cryogenic nozzle 100 can include a nozzle head 105. One end 106 (also referred as a first end) of the nozzle head 105 can be attached to the welding torch 101 using an attachment system 108 including such as brackets, fasteners, and/or clamps. An opposite end 107 (also referred as a second end) of the nozzle head 105 can be attached to a heat plate 115 and shower plate 109. A pipe 110 that is compatible with cryogenic temperatures can be attached to the nozzle head 105 to supply at least one cryogenic fluid to the cryogenic nozzle 100. The cryogenic fluid supplied to the cryogenic nozzle 100 can expand within, exit through the shower plate 109, and expand in volume again to form a gas shroud 111 to shield the feed wire, the arc (not visible in FIG. 1B), and the print parts.

FIG. 1C illustrates an enlarged view of the heat plate 115 and shower plate 109 in accordance with an embodiment. The shower plate 109 has rings of holes that pass the cryogenic fluids and direct them to flow downward. The shower plate 109 can have a center opening 113 where a tip of the welding torch 101 and the feed wire 103 can be fitted through. The shower plate has a plurality of holes 114 across the surface of the plate. The plurality of holes 114 can be arranged concentrically around the center opening 113. The cryogenic fluid exits the cryogenic nozzle 100 via the plurality of holes 114 to provide shielding, cooling, or both, for the welding torch 101 and the feed wire 103. The shower plate 109 has a relatively large surface area compared to a shielding gas outlet of the welding torch 101 so it can provide a large shielding coverage. The plurality of holes 114 can dissipate the cryogenic fluid and form a shielding that does not interfere with the printing processes. As can be readily appreciated, the number of holes, the placement of the holes, the shapes of the holes, and/or the sizes of the holes can be selected as appropriate to the requirements of specific applications in accordance with various embodiments.

FIG. 1D illustrates a cryogenic nozzle 105 attached to a welding torch 101 and a robotic arm 102 in accordance with an embodiment. The cryogenic nozzle 105 is concentrically positioned around the weld nozzle portion of the welding torch 101 and is configured to deliver cryogenic fluid for shielding or cooling during welding or additive manufacturing operations. The cryogenic nozzle 105 includes a cryogenic hose attachment point or opening 120, located at a lower portion of the nozzle, which is configured to couple with a supply line for delivering cryogenic fluid. The nozzle 105 can be used to direct the fluid around the arc zone, providing localized thermal regulation or inert shielding. A plurality of screw holes 117 are distributed around the nozzle 105 and are configured to enable mechanical fastening to the welding torch 101. These screw holes 117 provide secure and modular attachment for installation or replacement of components such as the shower plate 109. The nozzle 105 is further stabilized and secured to the welding torch 101 by a bracket 130 and a clamp 131. The bracket 130 supports the positioning of the nozzle 105 relative to the torch body, while the clamp 131 ensures firm retention under operating conditions such as vibration, thermal expansion, and contraction during prolonged use and movement of the robotic arm 102. The hose connection 120 and screw mounting system 117 allow for interchangeable nozzle types to be used based on material and process requirements, while the bracket 130 and clamp 131 ensure repeatably and mechanical robustness.

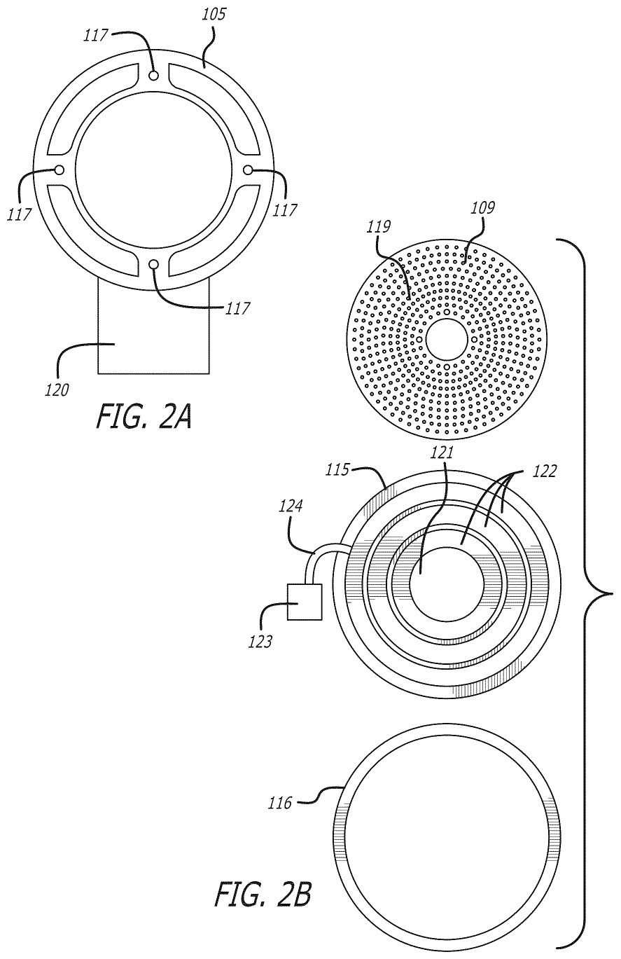

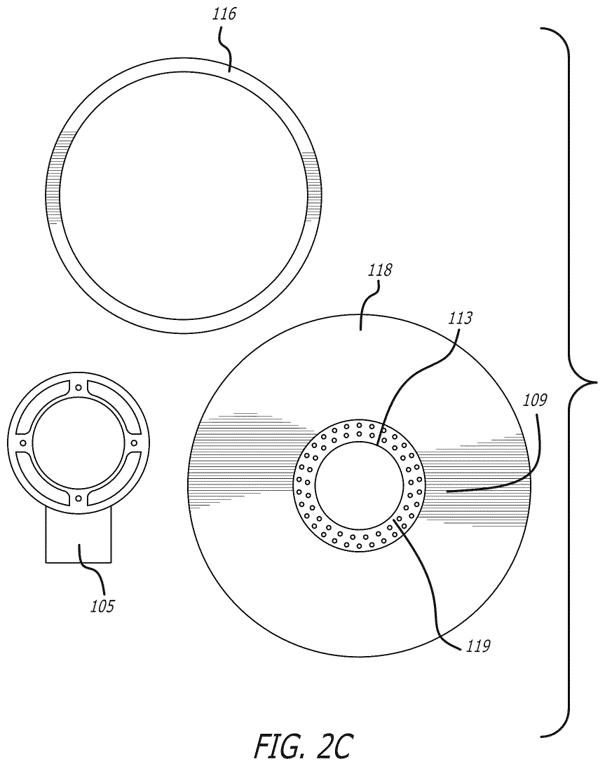

FIGS. 2A through 2C illustrate a disassembled cryogenic nozzle in accordance with an embodiment. The cryogenic nozzle 100 can include a nozzle head 105 (as shown in FIGS. 2A and 2C), a shower plate 109 (as shown in FIGS. 2B and 2C), a heat plate 115 (as shown in FIG. 2B), and a snap retaining ring 116 (as shown in FIGS. 2B and 2C). The second end 107 of the nozzle head 105 can have screw holes 117 for aligning and attaching to the plate 105. The nozzle head 105 shown in FIG. 2A has four screw holes 117 to attach to the shower plate 109. Although the nozzle head 105 shown in FIG. 2A has four holes, the number of holes and the placement of the holes can be varied as appropriate to the requirements of specific applications in accordance with various embodiments. The nozzle head 105 can be made with various types of materials that are compatible with cryogenic temperatures. Examples of the materials include (but are not limited to) metals, metal alloys, copper alloys, and brass. The nozzle head 105 can also include gaskets such as (but not limited to) O rings to ensure a tight seal. The nozzle head 105 has at least one opening 120 that can be attached to a pipe (such as 110 in FIG. 1B) and a storage tank to supply cryogenic fluids to the cryogenic nozzle 100. The pipe can be vacuum sealed with the nozzle head 105.

In many embodiments, cryogenic liquid cylinders or cryogenic storage dewars can be used to provide cryogenic fluids. Some embodiments use cryogenic compatible tubing (or lines, piping, hose) to transfer the cryogenic fluids. The tubing can be vacuum insulated to keep the cryogenic source cold during the transfer process. Keeping the cryogenic source cold can prevent the cryogenic fluids from evaporating and leaking. The tubing can be connected to at least one outlet of the cryogenic storage cylinder. In some embodiments, cryogenic specific regulators and/or diffusers can be used for flow control. The flow of the cryogenic fluids can be controlled by adjusting the composition and/or flow rate. Thermocouples can be used to monitor the temperature of the cryogenic fluids.

The shower plate 109 can have a top side 118 having a solid surface area, that is, having no holes. The top side 118 of the shower plate 109 is in contact with the second end 107 of the nozzle head 105. The shower plate 109 can have a bottom side 119 featuring the plurality of holes 114 for dissipating the cryogenic fluids. Cryogenic fluid entering the shower plate 109 from the nozzle head 105 flows radially outward in a cavity formed between the top side 118 and the bottom side 119 before exiting the holes 114. The shower plate 109 can be made with various types of materials that are compatible with cryogenic temperatures. Examples of the materials include (but are not limited to) metals, metal alloys, copper alloys, brass, stainless steel.

The cryogenic nozzle 100 can include a heat plate 115. The heat plate 115 can be attached to the top side 118 of the shower plate 109. The heat plate 115 has a center aperture 121 that aligns with the center opening 113 of the shower plate 109 such that the tip of the welding torch 101 and the feed wire 103 can be fitted through. The center aperture 121 has a larger diameter compared to the center opening 113. The larger center aperture 121 allows the cryogenic fluids to flow downward and through the plurality of holes 114 of the plate 109. The heat plate 115 can be made with various types of materials that are compatible with cryogenic temperatures. Examples of the materials include (but are not limited to) metals, metal alloys, aluminum alloys, aluminum.

The heat plate 115 can include one or more heating strips 122 (also referred as heating elements) that are arranged concentrically around the center aperture 121 and within the heat plate 115. The heating strips 122 can be connected to a power source 123 using lead wires 124. The heating mechanism of the heating strips 122 can be resistive heating or induction heating, for example. Electric energy can be applied to the heating strips 122 during cryogenic shielding, cooling, or both to heat up the cryogenic nozzle 100. In various embodiments, heating of the cryogenic nozzle 100 is desired because it can prevent over cooling or freezing of the cryogenic nozzle 100. Over cooling of the cryogenic nozzle 100 may lead to condensation, such that the cryogenic nozzle may freeze and the plurality of holes 114 may be blocked. Additionally, condensation may drip onto the print part, causing contamination. The heating temperature can vary with the amount of cryogenic fluid flow. A larger amount of cryogenic fluid may need a higher heating temperature, or more energy required to maintain a given heating temperature. The heating temperature can be adjusted via the input of the power source.

The snap retaining ring 116 engages the shower plate 109 with the heat plate 115 so the shower plate 109 and the heat plate 115 can be held together via tension. The snap retaining ring 116 can be made with various types of materials that are compatible with cryogenic temperatures. Examples of the materials include (but are not limited to) metals, metal alloys, stainless steel, steel. When in use, cryogenic fluids pass through the nozzle head 105 and out through the plurality of holes 114 of the shower plate 109. Room temperature shielding gas for the welding torch 101 comes out through the center opening 113.

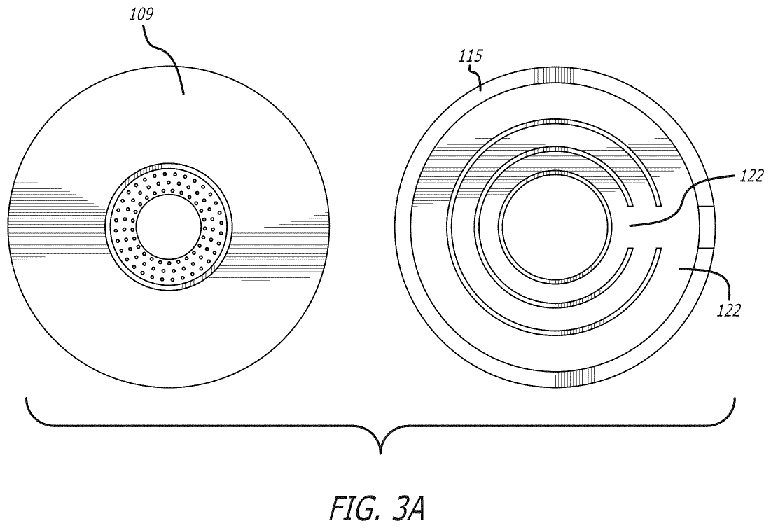

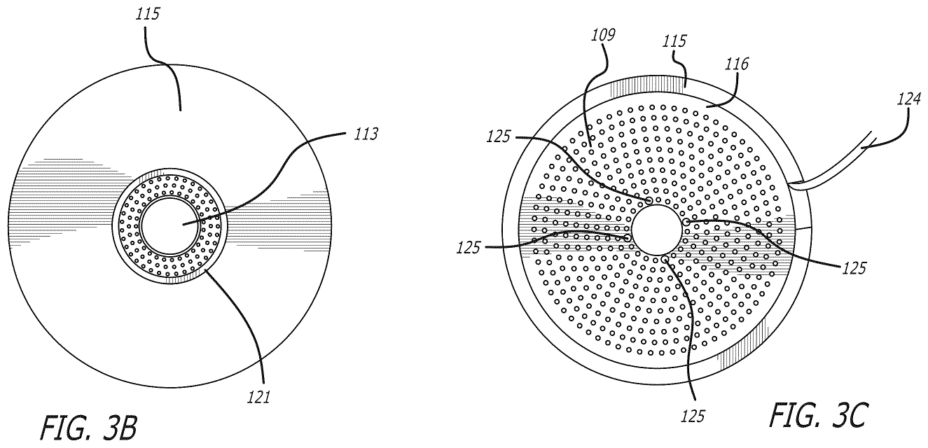

FIG. 3A illustrates the shower plate 109 and the heat plate 115 with the heating strips 122 in accordance with an embodiment. FIGS. 3B and 3C illustrate assembled shower plate and heat plate in accordance with an embodiment. FIG. 3B shows a view looking from the heat plate 115 side. The center aperture 121 of the heat plate 115 overlays the center opening 113 of the plate 109. FIG. 3C shows a view looking from the shower plate 109 side. The shower plate 109, the heat plate 115, and the snap retaining ring 116 are assembled together. The lead wires 124 for connecting the heat plate 115 with a power source can be seen. The shower plate 109 has four holes 125 around the center opening 113. The four holes 125 match and align with the four screw holes 117 of the nozzle head 105.

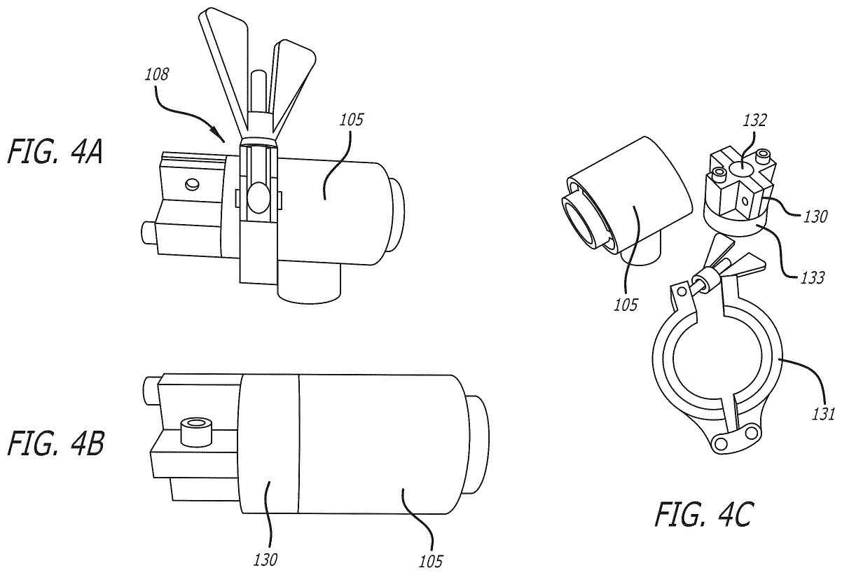

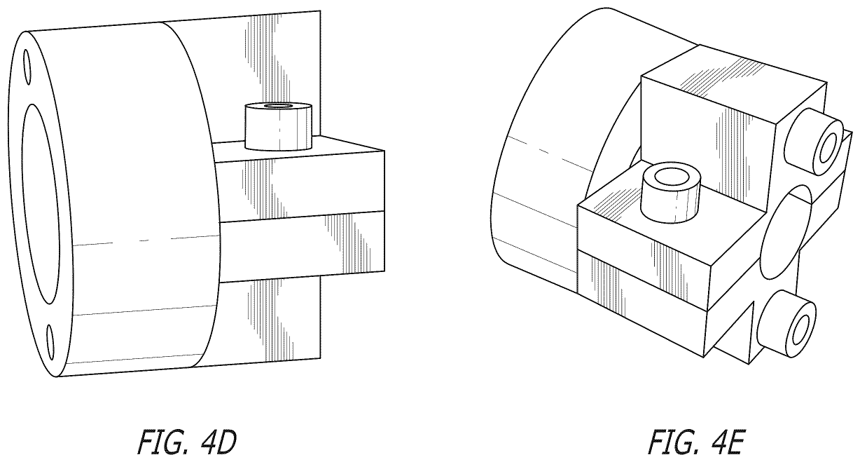

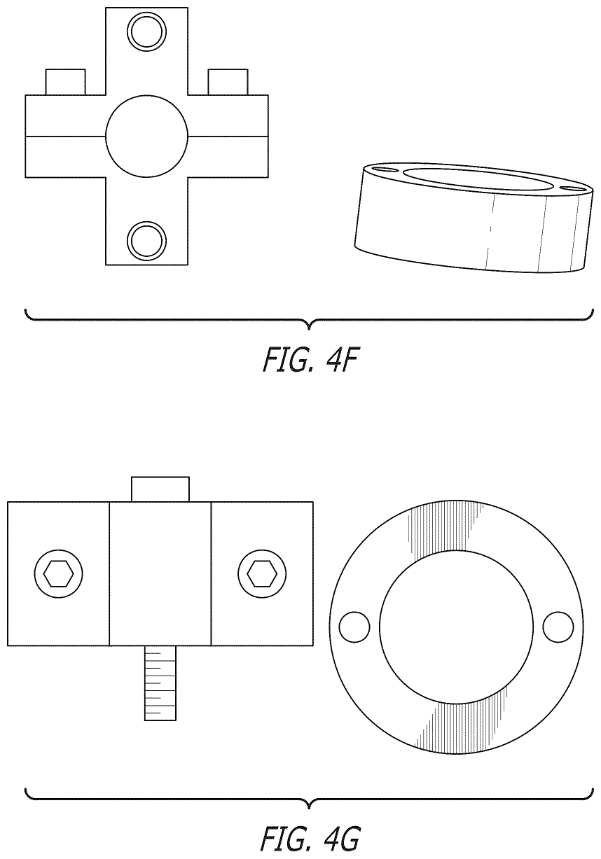

FIGS. 4A through 4G illustrate various parts of the attachment system in accordance with an embodiment. The attachment system 108 connects the welding torch 101 and the nozzle head 105 together. The attachment system 108 can include brackets 130 and clamps 131. The brackets 130 have a smaller end 132 and a larger end 133. The smaller end 132 fits with the welding torch 101, and the larger end 133 fits with the nozzle head 105. The brackets can be screwed together. The clamps 131 can hold the brackets 130 and the nozzle head 105 together as shown in FIG. 4A. FIGS. 4D through 4G show the assembled and the disassembled brackets.

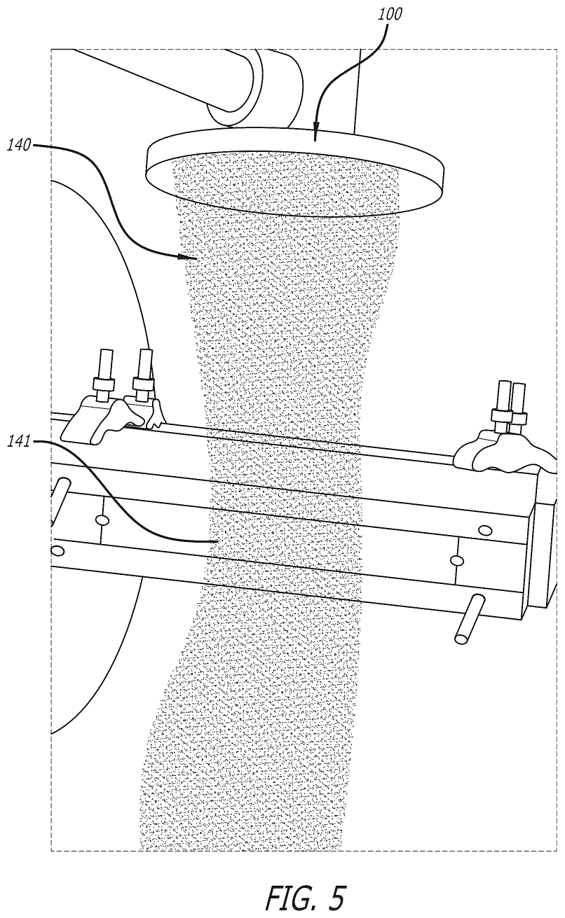

Many embodiments provide that the cryogenic shielding can prevent oxidation, corrosion, and/or environment contamination during additive manufacturing processes. The cryogenic shielding can eliminate the use of a chamber during printing. In some embodiments, the cryogenic shielding can form a self-enclosed environment that can insulate the feed wire(s), the arc, and the print part from the ambient environment. FIG. 5 illustrates a self-enclosed cryogenic environment in accordance with an embodiment. The flow of cryogenic fluid 140 out of the cryogenic nozzle 100 does not spread out after exiting the cryogenic nozzle 100. At downstream region 141, the cryogenic fluid flow 140 has narrowed. The emergent cryogenic fluid 140 thus exhibits a tendency to flow inward toward the central chill gas flow, the central shielding gas flow exiting the welding torch 101, or both, instead of the warmer and relatively stagnant ambient air. Thus, the cryogenic shielding forms a self-encased cryogenic environment without the need for a chamber. The self-encased cryogenic environment shields heated feed wire(s) and the print part from the atmosphere to prevent oxidation and other forms of contamination as discussed herein.

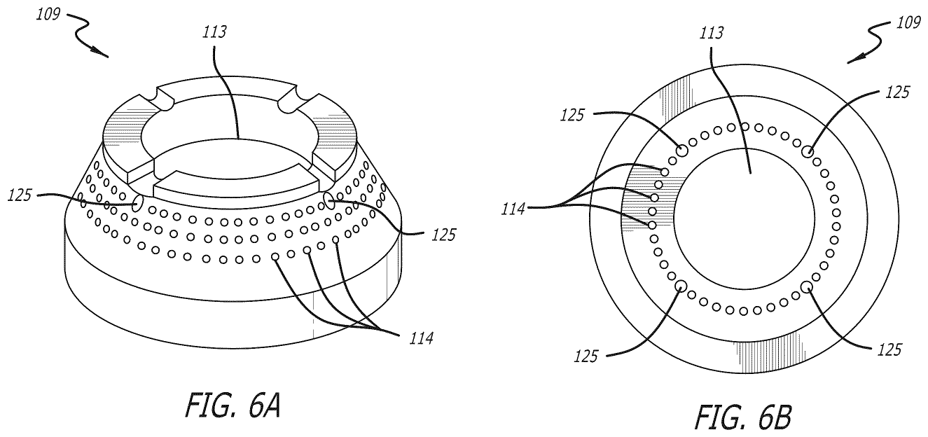

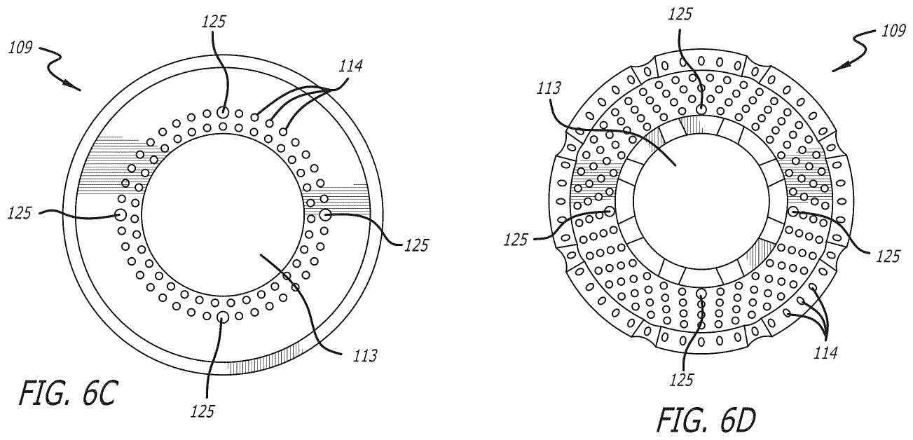

FIGS. 6A through 6D illustrate embodiments of the shower plate 109 configuration for use with the cryogenic nozzle 105 assembly. In each embodiment, the shower plate 109 comprises a center opening 113 through which the tip of the welding torch 101 may pass. Surrounding the center opening 113 is a plurality of holes 114 configured to discharge cryogenic fluid. The holes 114 are distributed in a pattern configured to direct cryogenic flow axially and/or radially to provide a shielding or cooling effect near the weld arc region, such as concentric rings. The cryogenic fluid exits nozzle the holes 114 and expands to form a protective gas shroud 111 over the weld zone. This shroud reduces oxidation, enhances thermal regulation, and can improve the surface quality of the deposited part.

As shown in FIGS. 6A though 6D, the shower plate 109 can be configured with a variety of the shower plate 109 geometries. In some embodiments, the holes 114 are configured with a set angle to direct cryogenic fluid, such as inward or downward, to produce a desired flow field, and a gas shroud 111. In some embodiments, the holes 114 are configured with a plurality of angles to produce complex flow patterns and gas shrouds 111. In many embodiments, the hole pattern and angle configurations are optimized for a specific material, part geometry, or deposition scenario.

In some embodiments, where arc sensitivity is high, such as titanium welding, a larger diameter configuration of the shower plate 109 can be utilized to ensure comprehensive shielding coverage. In some embodiments, such as for particular materials or parts with compact geometries, smaller shower head configurations can be utilized and configured for optimized flow control. In many embodiments, the plurality of holes 114, their angles, diameters, and spatial distribution may be tailored to the specific welding or additive manufacturing requirements. In many embodiments, the showerhead is produced using additive manufacturing techniques such as powder bed fusion. In many such embodiments, additive manufacturing enables the creation of intricate flow paths and geometries that would be difficult, impossible, or otherwise impractical to machine and produce using traditional methods.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A nozzle, comprising:
a nozzle head configured to couple with a welding torch, wherein the nozzle head is configured to connect to at least one cryogenic fluid;
a heat plate comprising a plurality of heating elements;
a shower plate comprising a plurality of holes, wherein the shower plate and the heat plate are coupled together, and wherein the plurality of heating elements are configured to heat the shower plate; and
wherein the at least one cryogenic fluid is configured to flow through the plurality of holes such that the at least one cryogenic fluid expands in volume when exiting the plurality of holes to form a gas shroud.

2. The nozzle of claim 1, wherein the gas shroud is configured to form a self-enclosed environment that shields a heated area during an additive manufacturing process from an ambient environment.

3. The nozzle of claim 1, wherein the welding torch is a MIG torch or a TIG torch.

4. The nozzle of claim 1, wherein the welding torch is configured to accommodate a feed wire and a shielding gas, and wherein a heat source is configured to melt the feed wire to form a molten feed wire, and wherein the molten feed wire is configured to be deposited on a substrate during an additive manufacturing process.

5. The nozzle of claim 4, wherein a tip of the feed wire extends through an opening of the shower plate, and wherein the gas shroud shields the molten feed wire during the additive manufacturing process.

6. The nozzle of claim 4, wherein the shielding gas is selected from the group consisting of: argon, helium, carbon dioxide, nitrogen, hydrogen, neon, and xenon.

7. The nozzle of claim 1, wherein the at least one cryogenic fluid is selected from the group consisting of: cryogenic liquid argon, cryogenic liquid nitrogen, cryogenic liquid helium, cryogenic liquid neon, cryogenic liquid oxygen, cryogenic liquid xenon, cryogenic argon gas, cryogenic nitrogen gas, cryogenic helium gas, cryogenic neon gas, cryogenic oxygen gas, cryogenic xenon gas, and cryogenic air.

8. The nozzle of claim 1, wherein the plurality of heating elements are configured to connect with a power source.

9. The nozzle of claim 1, wherein the nozzle head and the shower plate each have a plurality of connecting holes, and wherein the nozzle head and the plate are connected via the plurality of connecting holes.

10. A method for shielding in wire arc additive manufacturing (WAAM), comprising:
feeding a cryogenic fluid into a cryogenic nozzle, wherein the cryogenic nozzle comprises:
a nozzle head configured to couple with a welding torch;
a heat plate comprising a plurality of heating elements;
a shower plate comprising a plurality of holes, wherein the shower plate and the heat plate are coupled together; and
wherein the cryogenic fluid flows through the plurality of holes and expands in volume when exiting the cryogenic nozzle, and wherein the plurality of heating elements are configured to heat the shower plate to prevent condensation of the cryogenic fluid on the cryogenic nozzle.

11. The method of claim 10, wherein the cryogenic fluid has a temperature lower than or equal to −190° C.

12. The method of claim 10, further comprising connecting a cryogenic supply with the cryogenic nozzle via a vacuum seal.

13. A method for WAAM, comprising:
feeding a wire through a weld torch;
flowing a shielding gas through the weld torch such that the shielding gas surrounds the feed wire;
melting the wire using an arc and depositing the melted wire on a substrate to form an article; and
flowing a cryogenic fluid through a cryogenic nozzle coupled to the weld torch during deposition such that the cryogenic fluid expands in volume when exiting the cryogenic nozzle to form a secondary gas shield around the melted wire and the article.

14. The method of claim 13, wherein the secondary gas shield from the cryogenic fluid prevents the article from oxidizing.

15. A cryogenic shielding nozzle assembly comprising:
a nozzle body with an inlet portion and a flange portion;
wherein the nozzle body is configured to receive a cryogenic fluid from a cryogenic source via a fluid inlet disposed on the inlet portion of the nozzle body, and the nozzle body further comprising at least one mounting aperture disposed on the flange portion of the nozzle body;
wherein the nozzle body is configured to selectively couple to a weld nozzle such that the cryogenic shielding nozzle assembly concentrically surrounds at least a portion of the weld nozzle;
wherein each of the at least one mounting apertures is configured to receive a fastener element configured to couple the cryogenic shielding nozzle assembly to a shower plate assembly; and
wherein at least one outlet is disposed on the flange portion of the nozzle body, the at least one outlet being in fluid communication with the inlet and the shower plate assembly.

16. The cryogenic shielding nozzle assembly of claim 15, wherein the at least one mounting aperture comprises at least two mounting apertures disposed circumferentially about an axis of the nozzle body.

17. The cryogenic shielding nozzle assembly of claim 15, wherein the shower plate assembly comprises:
a shower plate body with a central aperture configured to concentrically surround at least a portion of the flange portion of the nozzle body;
a plurality of gas outlet holes disposed in an annular region of the shower plate body, each of the plurality of gas outlet holes being configured to discharge cryogenic fluid toward a target area.

18. The nozzle assembly of claim 17, wherein a plurality of the gas outlet holes are oriented at an oblique angle relative to a central axis of the aperture.

19. The cryogenic shielding nozzle assembly of claim 17, wherein the plurality of gas outlet holes are oriented perpendicular to the central axis of the aperture.

20. The cryogenic shielding nozzle assembly of claim 17, wherein the shower plate further comprises integral flow paths in fluid communication between each of the plurality of gas outlet holes and the at least one outlet.
